(19) United States
(12) Patent Application Publication
(10) Pub. No.: US 2003/0170360 A1
(43) Pub. Date: Sep. 11, 2003

(54) Device for foming an impression on meat products and method of using the same

(76) Inventors: Scott Donnel, Longmont, CO (US); Scott Schallenberger, Loveland, CO (US); Doug Stoneman, Greeley, CO (US)

Correspondence Address: Gray D. Lueck, BINGHAM MCCUTCHEN, LLP, Three Embarcadero Center, Suite 1800, San Francisco,, CA, 94111-4067, US

(21) Appl. No.: 10/092,096

(22) Filed: Mar. 6, 2002

(51) Int. Cl. C12C 3/04

(52) U.S. Cl. 426/412

(57) ABSTRACT

A device and a method for efficiently providing an impression, such as a netting impression, on meat products is provided. An exemplary device includes two members, each having a concavity from which extend protrusions for forming the impressions on a meat product. The meat product may be vacuumed packaged in film and sandwiched between the concavities of the two members, impressing the protrusions on the meat product outer surface. The members with impressed meat product are then heated for cooking the impression on the outer surface of the meat product.

### BACKGROUND OF THE INVENTION

This invention relates to a device and method for providing an impression on the surface of meat products.

In the preparation of pre-cooked meat products, as for example ham, roast beef, chicken, pastrami, turkey, etc., netting is commonly used for providing an impression of the outer surface of the meat product. Nets initially were used to hold together multiple pieces of a meat product such that the pieces were cooked together and sold as a single unit of meat product. When the meat products were cooked with the netting, the netting left an impression on the meat products. Nowadays, an impression is used on meat products for decorative purposes.

Current processes of preparing pre-cooked meat products require that the meat is stuffed within a net pouch and then vacuum packaged using a plastic film. The packaged meat is then cooked. After cooking is completed, the packaging and the netting are removed leaving a netting impression on the meat product and the meat product is repackaged for sale. This process due to its numerous steps is time consuming and costly. As such, a more efficient method and device for putting an impression on a meat product is desired.

### SUMMARY OF THE INVENTION

A device and a method are provided for efficiently providing an impression such as a netting impression on a meat product. In an exemplary embodiment, a device is provided having two members, each defining a concavity or depression having a plurality of protrusions forming a pattern. A meat product to be impressed is sandwiched between the two concavities such that the protrusions form an impression on the meat product outer surface. The device is heated so as to cook the impression on the meat product outer surface. The meat product is then removed from the device and cooked to a final state. In a preferred exemplary embodiment, the meat product is vacuumed packaged in a film prior to being placed within the concavities of the device for forming the impressions on the meat product outer surface. After the impressions are formed on the outer surface, the packaged meat product is removed from the device and may be cooked while still packaged to a desired state. Alternatively, the packaged meat product may be cooked to a desired state in the device.

### BRIEF DESCRIPTION OF THE DRAWINGS

FIG. 1 is a top view of an exemplary device of the present invention for forming an impression on a meat product.

FIG. 2 is an enlarged section of an inner surface of the exemplary device shown in FIG. 1.

FIG. 3 is an end view of the exemplary device shown in FIG. 1.

FIG. 4 is an end view of another exemplary embodiment device for forming an impression on a meat product.

FIG. 5 is a side view of an exemplary embodiment apparatus including a plurality of devices for forming impressions on multiple meat products.

FIG. 6 is a top view of the apparatus shown in FIG. 5.

FIG. 7 is an end view of another exemplary apparatus of the present invention for forming impressions on multiple meat products.

### DETAILED DESCRIPTION OF EXEMPLARY EMBODIMENTS OF THE INVENTION

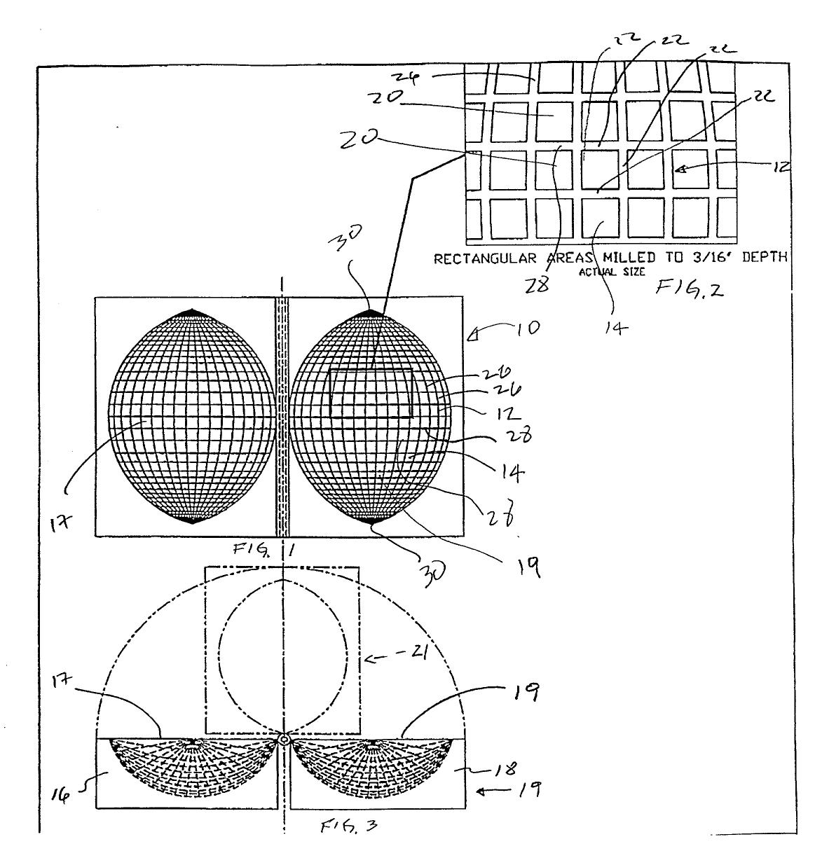

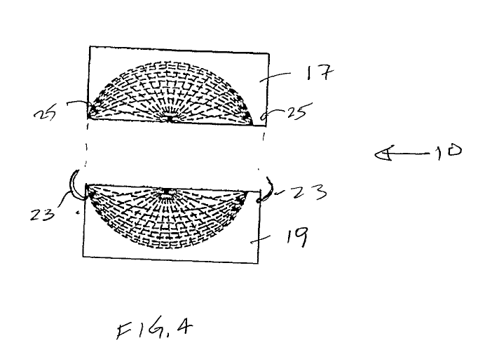

A device and a method are provided for efficiently providing an impression, such as a netting impression on meat products, as for example ham, turkey, chicken, pastrami, roast beef, etc. An exemplary device 10 is a clam shell device having a netting pattern 12 formed on its inner surface 14, as shown in FIGS. 1 and 2, for providing an impression on a meat product. The exemplary clam shell is composed of two members 16, 18, that are pivotally coupled to each other such that they can pivot between an open position 19 and a closed position 21, as for example shown in FIG. 3. Each clam shell member inner surface 14 defines a depression or concavity 17, 19 for surrounding and impressing a pattern on the meat product. In the exemplary embodiment device, the pattern is defined by a series of quadrilaterals 20 protruding from the inner surface 14 of each clam shell member 16, 18. Each quadrilateral is formed by four walls 22. In the exemplary embodiment, the quadrilaterals are defined by longitudinal linear protrusions 24 intersected by lateral linear protrusions 26. The impression surface or inner surface 14 of each clam shell member may be oval, spherical or have other various shapes. In the exemplary embodiment clam shell shown in FIG. 1, the impression surface is oval and it is defined by parallel lateral lines 28 and by longitudinal lines 26 extending between two common vertices 30 much like lateral and longitudinal lines on a globe. In the exemplary embodiment, the pattern is formed by milling the material out of the clam shell inner surface. The clam shell itself may be made from various materials used to make cooking devices, as for example stainless steel.

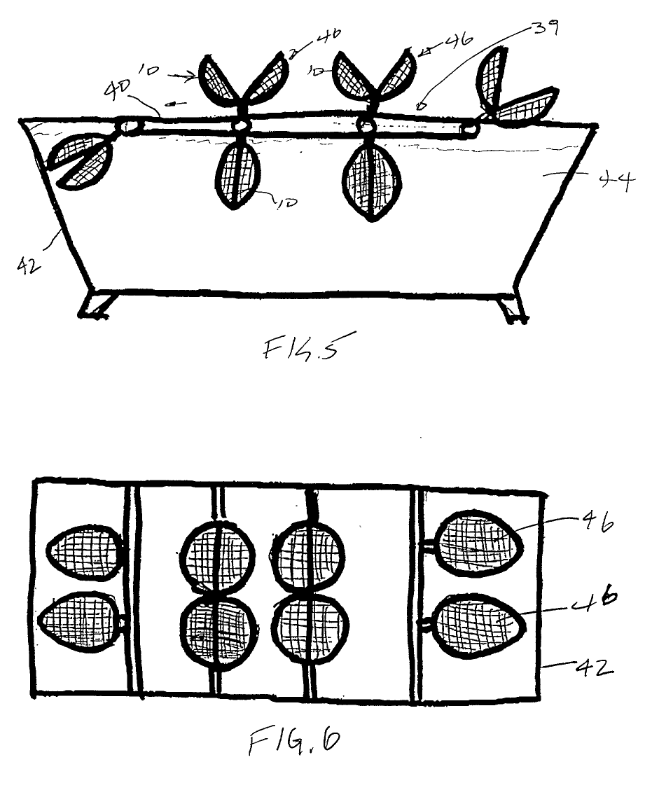

In an alternate exemplary embodiment, the clam shell may be composed of two members 17, 19 which are connected to each other using latches 23 extending from one of the members which latch into depressions 25 formed on the other member as for example shown in FIG. 4. The two members are separated to load the meat product and then are brought together and connected using the latches for forming the impression on the meat product.

Various size of clam shells can be made for accommodating various sizes of meat product. In the exemplary embodiment, the meat product is placed in the clam shell and the clam shell is closed. The meat product volume should be slightly greater than the volume defined by the impression surfaces of the clam shell members. In this regard, when the clam shell is closed, the protrusions 26, 28 of the clam shell penetrate the meat product providing an impression on the meat product outer surface. By controlling the height of the longitudinal and lateral linear protrusions 26, 28, the depth of the impression on the meat product can be controlled. In a preferred embodiment the height of each longitudinal and lateral linear protrusion is between about 2 mm to 4 mm for providing an impression on the meat product of about 2 mm to 4 mm deep.

Once the meat product is “clamped” within the clam shell, the clam shell is heated, as for example by placing it in hot water or through electricity. In an exemplary embodiment, the clam shell itself may be a heating element which heats up when supplied with electric current. The heat cooks the impression onto the surface of the meat product. The amount of heat and time of heating for cooking the impression on the meat product is determined based on the type of meat product being impressed. Once the impression is cooked on the meat product, the meat product is removed from the device and cooked to a predetermined desired state. Once cooked to a desired state, the meat product is ready for shipping. Typically, the meat product has been cooked to its desired state when it is cooked to about 160° F. internal temperature. The meat product may also be packaged preferably by vacuum packaging prior to cooking to the desired state.

In an alternate embodiment, in order to prevent contamination of the meat product by the heating medium as for example, the hot water, or the impression device, the meat product may be packaged, as for example vacuum packaged using a packaging film prior to forming the impression. The packaged meat product is placed into the clam shell for forming and cooking the impression onto the outer surface of the meat product. The meat product is then removed from the clam shell and cooked to its desired state with the packaging. Alternatively, the meat product may be cooked to its desired state while still in the clam shell. This may be accomplished by prolonging the heating time of the meat product when in the clam shell. In a further alternate embodiment, the packaging may be removed prior to cooking the meat product to its desired state.

The packaging used to package the meat product prior to forming the impression is preferably accomplished by using a film that does not shrink and that is relatively relaxed. Film packaging may be accomplished by vacuum packaging methods such as roll stock film packaging or heat shield bay packaging processes which are known in the art.

The clam shells can be closed to clamp the meat product either manually or mechanically. For example the clam shells may be coupled to actuators or other well known mechanical systems causing them to close relative to each other for “clamping” the meat product and to remain closed as necessary.

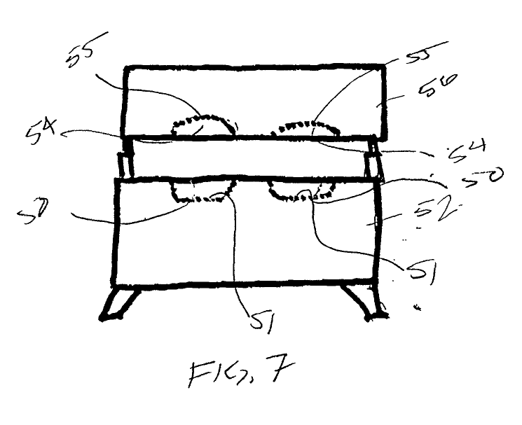

The entire impression process may be automated. In an exemplary embodiment, multiple clam shells 10 may be provided coupled to a conveyor system 39 having a conveyor belt 40, as for example shown in FIGS. 5 and 6. In the exemplary embodiment shown in FIGS. 5 and 6, two rows of clam shells are connected on the conveyor belt 40 which travels above a container 42 containing hot water 44 such that as the conveyor belt travels along the conveyor system, a portion of the belt faces away from the hot water and a portion of the belt faces the hot water.

As the conveyor belt travels the clam shells 46 connected to the portion of the belt facing away from the hot water open allowing the meat products to be removed and new meat products to be inserted into the clam shells. This can be accomplished automatically or manually. As the belt continues to travel along the conveyor system, the clam shells get submerged into the hot water. Prior to being submerged, the clam shells close “clamping” the meat product.

As the belt continues to travel, the clam shells remain submerged in the hot water until they reach an end of the conveyor system and are raised above the hot water. When that occurs, the clam shells open again to allow for removal of the impressed meat product and the loading of new meat product. While some of the clam shells are submerged in the hot water, i.e., the clam shells that are connected to the portion of the conveyor belt facing the hot water, the clam shells connected to the portion of the belt facing away from the hot water are open ready to be unloaded and reloaded with meat products.

The speed of the conveyor is such that the “clamped” meat product is retained within the hot water for a predetermined period of time for cooking the impression onto the outer surface of the meat product. Alternatively, the time that the clam shells remain submerged in the hot water may be sufficient for cooking the meat product to its final state.

In another alternate exemplary embodiment, multiple compartments 50 having impression surfaces 51 may be formed on a bed 52. Impression surfaces 54 are also formed on compartments 55 on a cover 56 that mates with the bed 52 as for example shown in FIG. 7. Each of the compartments 51 on the bed is aligned with a corresponding compartment 55 when the cover is mated to the bed. With this embodiment, meat products to be impressed is placed within the compartments 51 on the bed. The cover is then mated to the bed such that the meat product is “clamped” between opposite impression surfaces 50, 54 of the corresponding compartments 51, 55. The mating of the cover to the bed may be accomplished by hydraulic pressure. Once the meat product is “clamped”, heat is applied to the impression surfaces 50 and 54 for cooking the impression on the meat products. The impression surfaces 50, 54 may be heating surfaces that heat up when supplied with electricity. Alternately, steam or hot water may be applied to heat the impression surfaces. The steam or hot water may be applied by submerging the bed and cover in steam or hot water bath or by supplying steam or hot water to the bed and cover as for example by supplying steam or hot water to areas in the bed and cover surrounding the impression surfaces. As with the previous embodiments, the impressions or the meat product may be accomplished prior to packaging or after packaging.

Once, the impression has been formed on the meat product, cooking to a desired state may be accomplished by placing the meat products onto the cooking rack while packaged or unpackaged. Alternatively, the meat products may be cooked to their desired state while “clamped” in the device used to form the impression.

As can be seen with the inventive device and process, the amount of time to form an impression such as a net impression on meat product is reduced since netting does not have to be applied and removed and since the product can be impressed with the netting pattern without having to remove the packaging. Consequently, the throughput, and costs for forming the impression on meat products are decreased.

Although this invention has been described by way of exemplary embodiments, the invention is not to be limited only to such embodiments. As for example, the clam shells may be made only from wiring and the depth of the impressions may be controlled by controlling the amount of pressure used to clamp the meat product within the wire clam shells. In other embodiments, the pattern formed within a clam shell for providing an impression on a meat products may be varied. For example, squares, diamonds or other geometric shapes may be formed instead of rectangles.

What is claimed is:

1. A method for processing meat products comprising:
providing a first member comprising a first surface defining a concavity and comprising a plurality of protrusions extending from said first surface and arranged in a first pattern;
providing a second member comprising a second surface defining a concavity comprising a plurality of protrusions extending from said second surface and arranged in a second pattern;
providing a meat product;
sandwiching the meat product between the first and second surfaces impressing the first and second patterns on the meat product;
heating the meat product within the two members for cooking the impressed patterns on the meat product;
removing the impressed meat product from the two members; and
cooking the meat product to a desired state.

2. A method as recited in claim 1 further comprising packaging the meat product in a film prior to sandwiching the meat product between the two members, wherein sandwiching comprises sandwiching the packaged meat product between the two members impressing the first and second patterns on the meat product, and wherein heating comprises heating the packaged meat product within the two members for cooking the impressed patterns on the packaged meat product.

3. A method as recited in claim 1 wherein the first and second patterns are the same.

4. A method as recited in claim 1 wherein heating comprises immersing the two members with meat product in hot water.

5. A method as recited in claim 1 wherein heating comprises electrically heating the two members.

6. A method as recited in claim 1 wherein heating comprises applying heat to the two members.

7. A method as recited in claim 1 wherein heating comprises applying steam to the two members.

8. A method as recited in claim 1 further comprising pivotally coupling the first member to the second member.

9. A method as recited in claim 1 wherein sandwiching comprises applying hydraulic pressure on one of said first and second members.

10. A method as recited in claim 1 wherein providing a first member comprises providing a member having a plurality of longitudinal protrusions and a plurality of lateral parallel protrusions.

11. A method as recited in claim 1 further comprising:
positioning a conveyor having a belt over a container containing hot water; and
coupling the two members on the conveyor belt, wherein cooking the meat product within the two members comprises rotating the conveyor belt to submerge the members into the hot water.

12. A method as recited in claim 11 further comprising:
providing a third member coupled to the conveyor belt comprising a third surface defining a concavity and comprising a plurality of protrusions extending from the third surface and arranged in a third pattern;
providing a fourth member coupled to the conveyor belt comprising a fourth surface defining a concavity and comprising a plurality of protrusions extending from the fourth surface and arranged in a fourth pattern;
rotating the conveyor belt placing the third and fourth members over the water in the container;
packaging a second meat product in a film;
placing the second packaged meat product between the third and fourth surfaces;
sandwiching the second packaged meat product between the third and fourth surfaces impressing the third and fourth patterns on the second packaged meat product; and
rotating the conveyor belt placing the third and fourth members in the hot water for cooking the impressed third and fourth patterns on the second packaged meat product.

13. A method as recited in claim 12 wherein when the first and second members are not in the hot water, the third and fourth members are submerged in the hot water.

14. A method for processing meat products comprising:
providing a first member having a plurality of first depressions each first depression comprising a plurality of protrusions;
providing a second member having a plurality of second depressions corresponding to the plurality of first depressions, each of the second depressions comprising a plurality of protrusions;
placing meat products in each of said plurality of first depressions;
aligning the first member with the second member wherein each of said first depressions is aligned with a second depression;
sandwiching the first and second members impressing the protrusions of a first and second depression on each of said meat products forming impressions on the outer surfaces of the meat products;
heating the meat products within the two members for cooking the impressions on the meat products; and
removing the meat products from the two members.

15. A method as recited in claim 14 further comprising cooking the meat products to a desired state.

16. A method as recited in claim 14 further comprising packaging the meat products in a film prior to sandwiching the meat product between the two members, wherein sandwiching comprises sandwiching the packaged meat products between the two members impressing the protrusions of the first and the second depression on said meat products forming impressions on the outer surfaces of the meat products, and wherein cooking comprises cooking the packaged meat products within the two members for cooking the impressions on the packaged meat products.

17. A method as recited in claim 16 further comprising cooking the packaged meat products to a desired state.

18. A method as recited in claim 14 wherein sandwiching comprises applying hydraulic pressure on one of said first and second members against the other of said first and second members.

19. A method as recited in claim 14 wherein each of the first depressions and second depressions comprise a plurality of longitudinal protrusions and a plurality of lateral parallel protrusions.

20. A method as recited in claim 14 wherein heating comprises electrically heating the first and second depressions.

21. A method for processing a meat product comprising:
packaging the meat product;
providing an impression on the packaged meat product outer surface while packaged;
heating the packaged meat product to cook the impression on the meat product outer surface; and
cooking the meat product to a desired state.

22. A method as recited in claim 21 wherein providing an impression comprises sandwiching the meat product in a compartment of an impression device having protrusions which impress into the packaged meat product outer surface.

23. A method as recited in claim 22 wherein heating comprises heating the device.

24. A method as recited in claim 23 further comprising removing the packaged meat product from the device after heating and before cooking.

25. A method as recited in claim 24 further comprising providing a cooking device separate from the impression device 5 for cooking the meat product to a desired state.
